(19) United States
(12) Patent Application Publication
(10) Pub. No.: US 2003/0208943 A1
(43) Pub. Date: Nov. 13, 2003

(54) Waterfowl decoy system and method for using same

(76) Inventor: Mark Beam, Brighton, CO (US)

Correspondence Address: PATTON BOGGS, PO BOX 270930, LOUISVILLE, CO, 80027, US

(21) Appl. No.: 10/144,098

(22) Filed: May 13, 2002

(51) Int. Cl. A01M 31/06

(52) U.S. Cl. 43/3

(57) ABSTRACT

A waterfowl decoy system and method for attracting waterfowl to a particular location. The waterfowl decoy system comprises a waterfowl decoy and an instructional apparatus. The waterfowl decoy comprises a wing-shaped body made of corrugated plastic. In the method, the wing-shaped body is moved by a user to imitate waterfowl airing themselves out, thereby attracting approaching waterfowl to a particular location. The waterfowl decoy system comprises a standard size waterfowl decoy used when waterfowl are relatively close and a magnum size waterfowl decoy used when the waterfowl are relatively far away.

### BACKGROUND OF THE INVENTION

1. Field of the Invention

The present invention relates generally to the field of small game hunting, and more specifically to a decoy system for use in bird hunting, particularly waterfowl hunting.

2. Statement of the Problem

Early man evolved as a hunter, and many people find this activity enjoyable as a hobby even today. Accordingly, hunters have developed innumerable means for attracting and capturing wild game in the field. As an example, the use of floating and/or other decoys is well known for attracting waterfowl (e.g., ducks, geese, etc.) to concealed hunters. Typically, prior art decoys float on the surface of a body of water.

However, conventional decoys are inanimate objects, and do not provide the movement required to simulate real waterfowl airing out their wings, resting or swimming on land or on the surface of a body of water. The unrealistic appearance of stationary, inanimate decoys positioned on the land or floating on the surface has proven to be less than optimally effective in attracting other waterfowl flying overhead, and causing those waterfowl to join the decoys in order to come within range of the hunter(s). The vast majority of decoys available to the hunter are stationary. Traditional decoys are generally positioned on the water surface and are subject to water and air motions for their movement. Hunters have long sought to facilitate movement of waterfowl decoys in order to make such decoys appear more live and realistic.

Further, a vast majority of decoys available to the hunter are cumbersome and heavy. Typically, a string or plurality of decoys is utilized in the field to lure waterfowl into a particular area. As many as fifty to one hundred decoys are often required to be dispersed in the area of twenty yards to thirty yards in radius to simulate a game fowl feeding and resting ground. Carrying this number of decoys around can be cumbersome and tiresome.

In addition, the mechanical aspects of typical decoys are compromised over time, as they are continually subjected to dropping, water and wind. These physical forces wear out typical decoys thereby requiring maintenance to extend the lifetime and usefulness of the decoys. As the number of decoys employed increases, so does the time required to maintain these decoys in useful condition.

Further, the effectiveness of typical decoys is dependent on several factors, including: appearance, setting, motion, size and number of decoys employed. Oftentimes, the effectiveness is minimal due to the wrong mixture or combination of these factors. For example, a single decoy with appropriate appearance will not be as effective as a plurality of decoys with similar appearance.

3. Solution to the Problem

The present invention relates to a waterfowl decoy system incorporating a unique combination of elements which cooperate in a unique manner to provide a highly effective attractant to flying waterfowl, such as ducks or geese.

The present invention solves the above problems by providing a system and method for attracting waterfowl to a particular location. The system includes a waterfowl decoy that has a wing-shaped body and a handle. The waterfowl decoy is grasped by the user and moved to imitate a flapping wing motion of a waterfowl. The system also includes an instructional apparatus to instruct the user how to imitate a flapping wing motion of a waterfowl using the wing-shaped decoy. The present invention also includes a method for attracting waterfowl to a particular location.

The present invention provides a waterfowl decoy that provides the movement required to simulate real waterfowl airing their wings out, resting on land or resting or swimming on the surface of a body of water. The realistic appearance of the waterfowl decoy being motioned by a user has proven to be optimally effective in attracting waterfowl to a particular location.

The present invention also provides a waterfowl decoy that is not cumbersome and heavy. The invention provides lightweight waterfowl decoys that can be easily carried into the field by a hunter. The invention provides one waterfowl decoy or a plurality of waterfowl decoys. Preferably, two waterfowl decoys are used to imitate the wing-flapping motion of a waterfowl.

The present invention also provides waterfowl decoys that are devoid of moving parts, thereby eliminating required maintenance normally associated with conventional mechanical waterfowl decoys. This eliminates the time involved in maintaining the decoys in useful condition.

The present invention also provides effective waterfowl decoys. The shape and color of the waterfowl decoys, combined with the flapping motion of their wings, provides an effective waterfowl decoy. The size and shape of the waterfowl decoys provides an effective decoy for luring waterfowl to a particular location.

The present invention provides a waterfowl decoy system comprising: a wing-shaped body, a handle, and an instructional apparatus for instructing a user to imitate with the wing-shaped decoy the flapping motion of a waterfowl's wings. Preferably, the handle contains a slot, wherein the slot facilitates the holding by a user of the wing-shaped decoy. Preferably, the body contains a window, and preferably, the window is located to facilitate the covert viewing of the waterfowl. Preferably, the wing-shaped body comprises a corrugated plastic. Preferably, the corrugated plastic is Coreplast™. Preferably the wing-shaped body comprises a standard size. Preferably, the wing-shaped body comprises a magnum size. Preferably, the wing-shaped body is shaped in the form of an extended wing of a waterfowl. Preferably, the waterfowl is selected from the group consisting of ducks and geese. Preferably, the handle is thicker than said wing-shaped body. Preferably, the handle comprises an additional cross-grain section of Coreplast™. Preferably, the instructional apparatus includes instructions regarding the motion required to imitate the flapping motion of said waterfowl. Preferably, the wing-shaped body is colored. Preferably, the color is black. Preferably, the body is colored white and the edges of the wing-shaped body are colored black.

In another aspect, the invention provides a waterfowl decoy comprising: a wing-shaped body and a handle. Preferably, the handle comprises a slot in the body. Preferably, the wing-shaped body contains a window, and preferably the window is located to facilitate the covert viewing of the waterfowl. Preferably, the wing-shaped body comprises corrugated plastic. Preferably, the corrugated plastic is Coreplast™. Preferably, the wing-shaped body comprises a standard size. Preferably, the wing-shaped body comprises a magnum size. Preferably, the wing-shaped area is shaped in a form of an extended wing of a waterfowl. Preferably, the waterfowl is selected from the group consisting of ducks and geese. Preferably the wing-shaped body is thicker in the area of the handle. Preferably, the handle comprises an additional cross-grain section of corrugated plastic. Preferably, the corrugated plastic is Coreplast™. Preferably, the wing-shaped body is colored. Preferably, the color is black. Preferably the wing-shaped body is colored white and the edges of the wing-shaped body are colored black.

In a further aspect, the invention provides a waterfowl decoy comprising: a substantially planar wing-shaped body, and a handle formed in said body. Preferably, the handle comprises a slot in the body. Preferably, the wing-shaped body contains a window, and, preferably, the window is located to facilitate the covert viewing of the waterfowl. Preferably, the wing-shaped body comprises corrugated plastic. Preferably, the corrugated plastic is Coreplast™. Preferably, the wing-shaped body comprises a standard size. Preferably, the wing-shaped body comprises a magnum size. Preferably, the wing-shaped area is shaped in a form of an extended wing of a waterfowl. Preferably, the waterfowl is selected from the group consisting of ducks and geese. Preferably, the body is thicker in the area of the handle. Preferably, the handle comprises an additional cross-grain section of corrugated plastic. Preferably, the corrugated plastic is Coreplast™. Preferably, the wing-shaped body is colored. Preferably, the color is black. Preferably, the wing-shaped body is colored white and the edges of the wing-shaped body are colored black.

Numerous other features, objects and advantages of the invention will become apparent from the following description when read in conjunction with the accompanying drawings.

### BRIEF DESCRIPTION OF THE DRAWINGS

FIG. 1A is a diagram of the standard sized waterfowl decoy;

FIG. 1B is a diagram of the magnum sized waterfowl decoy;

FIG. 2 is a portion of a cross-section of FIGS. 1A and 1B taken through the lines 2-2 illustrating the cross-section of the waterfowl decoy;

FIG. 3 is a diagram of the waterfowl decoy system with the wing-shaped body held in a first position; and

FIG. 4 is a diagram of the waterfowl decoy system with the wing-shaped body held in a second position.

### DETAILED DESCRIPTION OF THE PREFERRED EMBODIMENT

1. Overview

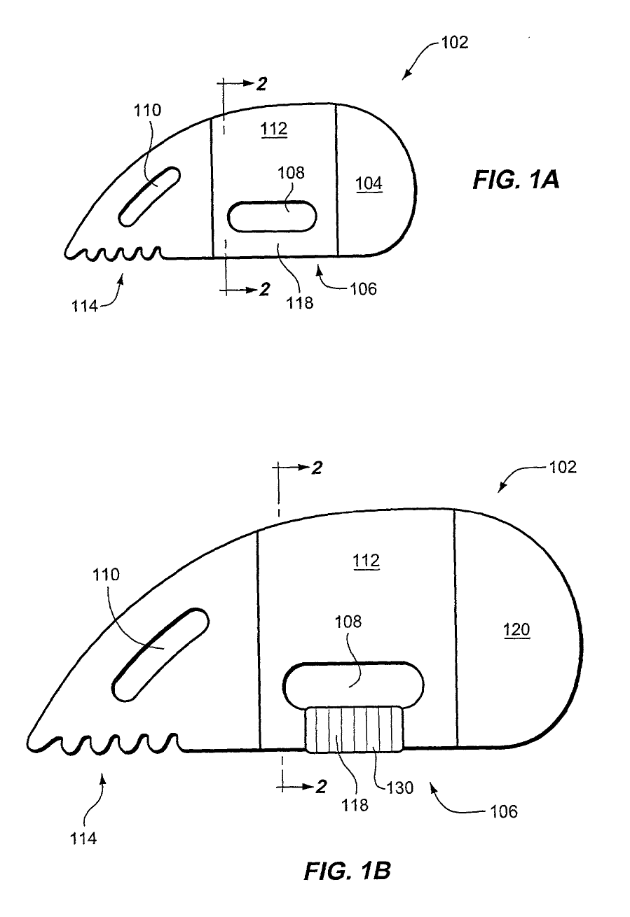

A preferred embodiment of a waterfowl decoy system 102 is shown in FIG. 1A. System 102 comprises a wing-shaped body 104. Preferably, system 102 comprises a pair of wing-shaped bodies 104. More preferably, the waterfowl decoy system includes two different sized waterfowl decoys, a standard size 104 and a magnum size 120, shown in FIG. 1B. Both sizes are shown on one sheet so the reader can obtain an idea of the comparative sizes. However, it is important to understand that there can be more than two sizes of decoys in system 102, and the relative sizes can vary. In this disclosure, for simplicity, only two different sizes are discussed. In this disclosure, one size is called a “standard” size and the larger size is called a “magnum” size, to differentiate them with terms that are descriptive. However, it should be understood that the name is not important; what is important is that there are different sizes. As shown in FIGS. 1A and 1B, preferably, standard body 102 and magnum body 120 have the same shape and features, though this is not required. Generally, the larger-sized decoy is used when the waterfowl are relatively far away, and the smaller-sized decoy is used when the waterfowl are relatively close.

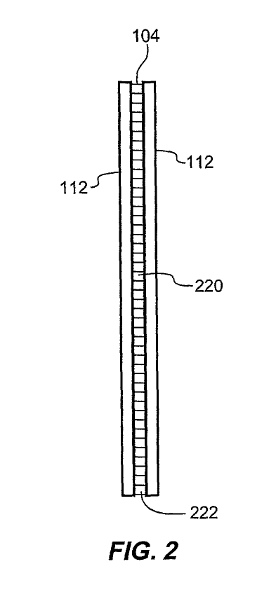

In FIG. 1A is shown a standard size waterfowl decoy 102 according to the present invention. The standard size decoy's length is between one foot and three feet and the height is between six inches and eighteen inches. The standard size waterfowl decoy 102 has a body 104 that is made of corrugated plastic, preferably Coreplast™. The thickness of body 104 is between two millimeters (mm) and ten millimeters (mm). Body 104 is shaped in the form of an extended waterfowl wing. Body 104 has a handle 106 that facilitates grasping of the standard size waterfowl decoy 102 by a user. Preferably, handle 106 comprises a slot 108 formed in the body and a handle portion 118 of body 104 that is grasped by the user. Slot 108 is of a size that enables a user to insert his fingers into slot 108 for grasping. Preferably, slot 108 has a height of one inch to three inches and a width of four inches to eight inches. Body 104 further preferably includes a window 110. Window 110 has two functions: it facilitates covert viewing by a user, and it allows the wing to be flapped more easily because it allows air to pass through the wing of body 104. Window 110 allows the user to view approaching waterfowl while camouflaging the user. Preferably, the standard size decoy 102 is thicker in handle 106 than body 104. Handle 106 can comprise a reinforced section 112 made of corrugated plastic, preferably Coreplast™. Reinforced section 112 preferably comprises two pieces of corrugated plastic, one on either side of body 104, as shown in FIG. 2. However, one reinforcement piece may also be used. Preferably, reinforced section 112 is a cross-grain section of Coreplast™ as shown in FIG. 2. That is, the corrugations in the reinforcement run in a different direction in reinforced section 112. Reinforced section 112 is typically the same thickness as body 104; specifically, the thickness is of reinforced section 112 is between two mm and ten mm, though this is not necessary. Where one piece of reinforced section 112 is employed, the combined thickness of body 104 and reinforced section 112 will be between four mm and twenty mm. Where two pieces of reinforced section 112 are employed, one reinforced section 112 on each side of body 104, the combined thickness of body 104 and the two pieces of reinforced section 112 will be between six mm and thirty mm. Waterfowl decoy 102 has a wing tip end 114 that imitates the wing tip of a waterfowl. Waterfowl decoy 102 can be colored any color desirable, but preferably is colored black. Preferably, waterfowl decoy 102 may also be colored in a color that imitates the colors of a waterfowl's wings. For example, the major portion of waterfowl decoy 102 can be colored white with the wing tip end 114 colored black, which imitates the color of a common goose variety.

As mentioned above, FIG. 1B depicts a magnum size waterfowl decoy 120, for comparison with the standard size of FIG. 1. The elements of the magnum size waterfowl decoy 120 are preferably the same as for the standard size decoy 102 but are generally larger in size, so the numbering of the elements are the same for the standard size waterfowl decoy 102 and the magnum size waterfowl decoy 120. The magnum size decoy's length is between three feet and five feet and the height is between twelve inches and twenty-four inches. An additional element of the invention, a handle pad 130, is shown in FIG. 1B. Handle pad 30 may be tape or other material wrapped around handle portion 118, a molded plastic grip, dense foam, or other material that enlarges handle portion 118 to make it easier to grip and provides a surface that is comfortable and wears well. Preferably, handle pad 30 is of a form that is replaceable.

FIG. 2 is a cross-section view as seen through section 2-2 in FIGS. 1A and 1B. Body 104 is viewed in FIG. 2 as a cross-section, and it shows the orientation of the ribs or corrugations of the corrugated material. Also shown in FIG. 2 is the cross-selection of two pieces of reinforced section 112 adjacent to body 104. The orientation of the Coreplast™ corrugations in body 104 is shown in FIG.2 to be perpendicular to the orientation of reinforced section 112. In another example, the corrugations in one section 112 can run at forty-five degrees to the corrugations in body 104, and the corrugations in the other reinforced section 112 can run at forty-five degrees to the corrugations in body 104. In FIG. 2, corrugations 220 of body 104 run into the figure; therefore, open ends 222 of the hollow corrugations can be seen.

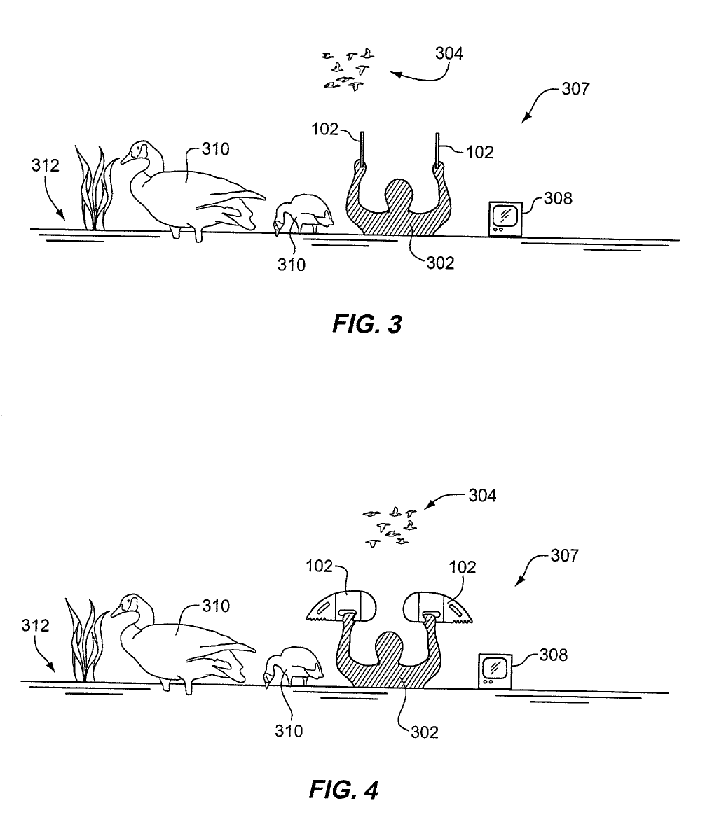

Directing attention to FIG. 3, a waterfowl decoy system 307 comprising a pair of waterfowl decoys 102 and an instructional apparatus 308 is shown. In this example, the instructional apparatus is a videotape that is being played and displayed on a portable television. The instructional apparatus 308 may also be used prior to traveling to the field. For example, the instructional apparatus can be viewed in the home. In another example, the instructional apparatus could be viewed in an automobile prior to entering the field. Also, in this example, as mentioned above, the waterfowl decoy can be the standard size waterfowl decoy 102 or the magnum size waterfowl decoy 120, or both. A user 302 is in a pit below the ground 312; therefore, only the upper portion of the user's body is exposed above the surface. In the upper portion of FIG. 3, waterfowl 304 are depicted as approaching user 302. User 302 is holding a standard size waterfowl decoy 102 in each hand and they are oriented with the face of waterfowl decoy 102 substantially parallel to the line of sight from the user to approaching waterfowl 304. Optionally, other conventional decoys 310 are placed beside the user to imitate a group of waterfowl eating along the ground 312.

FIG. 4 shows user 302 moving the standard size decoy 102 so that orientation of the face of the decoy is substantially perpendicular to the line of sight from the user to approaching waterfowl 304. As mentioned above, the waterfowl decoy can be either the standard size waterfowl decoy 102 or the magnum size waterfowl decoy 120. Optionally, the user can camouflage his body by covering it with the standard size decoy 102 and peering through window 110 of the standard size waterfowl decoy and the magnum size waterfowl decoy.

The standard size waterfowl decoy 102 and the magnum size waterfowl decoy 120 show idealized representations of an extended waterfowl wing which are employed to depict more clearly and fully the structure and process of the invention than would otherwise be possible. Also, the standard size waterfowl decoy 102 and magnum size waterfowl decoy 120 represent only two of innumerable variations of waterfowl wing-shaped bodies that could be fabricated.

### EXAMPLE 1

Attracting Waterfowl From Afar

Several conventional waterfowl decoys 310 are deployed in the field where waterfowl 304 are expected to fly by. User 302 holds a magnum size waterfowl decoy 120 in each hand, whereby body 104 of the magnum size waterfowl decoy 120 is in a first position substantially parallel to the line of sight between user 302 and approaching waterfowl 304. The magnum size waterfowl decoys 120 are oriented so that the handle of the decoy is below the curved portion of wing-shaped body 104. User 302 then rotates the decoys so that the bodies of the decoys are in a second position substantially perpendicular to the line of sight between the hunter and the approaching waterfowl. The wing tips of the decoys in this position are distal from the user. The user then rotates the decoys back to the first position. The user then continues to rotate the decoys between these positions until the geese are attracted to this motion and fly toward the user.

### EXAMPLE 2

Attracting Waterfowl Closer By

Several conventional waterfowl decoys 310 are deployed in the field where waterfowl 304 are expected to fly by. User 302 holds a standard size waterfowl decoy 102 in each hand in a first position in which body 104 of the standard size waterfowl decoy 102 is substantially parallel to the line of sight between user 302 and approaching waterfowl 304. The standard size waterfowl decoy 102 is oriented so that the handle of the decoy is below the curved portion of wing-shaped body 104. The user then rotates the decoy so that the bodies of the decoys are in a second position substantially perpendicular to the line of sight between the hunter and the approaching waterfowl. The wing tips of the standard size waterfowl decoys 102 in this position are distal from the user. The user then rotates the standard size waterfowl decoys 102 back to the first position. The user then continues to rotate the decoys between these positions until the geese are attracted to this motion and fly toward the user. This rotating motion can be faster than the motion used with the magnum size waterfowl decoy 120 described in Example 1.

### EXAMPLE 3

Covert Viewing Of Approaching Waterfowl

A user grasps one magnum size waterfowl decoy 120 in each hand and, holding the magnum size waterfowl decoy 120 with the curved portion of wing-shaped body 104 pointing upward and the handle below, the user covers himself up with the magnum size waterfowl decoy 120 and peers through window 110 to view the approaching waterfowl.

### EXAMPLE 4

One Decoy And One Waterfowl Call

A user grasps one magnum size waterfowl decoy 120 in one hand and a waterfowl call in the other and rotates the magnum size waterfowl decoy 120 as described in Example 1 while sounding the waterfowl call.

### EXAMPLE 5

Using A Magnum Size Waterfowl Decoy And A Standard Size Waterfowl Decoy

User 302 holds a standard size waterfowl decoy 102 in one hand and a magnum size waterfowl decoy 120 in the other, whereby body 104 of the standard size decoy 102 and the magnum size waterfowl decoy 120 are substantially parallel to the line of sight between user 302 and approaching waterfowl 304. The standard size waterfowl decoy 102 and the magnum size waterfowl decoy 120 are oriented so that the handles of the decoys are below the curved portion of wing-shaped body 104. The user then rotates the decoys so that the bodies of the decoys are substantially perpendicular to the line of sight between the hunter and the approaching waterfowl. In this position, the wing tips of the standard size waterfowl decoy 102 and the magnum size waterfowl decoy 120 are distal from the user. The user then rotates the standard size waterfowl decoy 102 and the magnum size waterfowl decoy 120 back to the first position. The user then continues to rotate the decoys between these positions until the geese are attracted to this motion and fly toward the user.

There has been described a system and method for attracting waterfowl to a particular location. It should be understood that the particular embodiments shown in the drawings and described within this specification are for purposes of example and should not be construed to limit the invention which will be described in the claims below. Further, it is evident that those skilled in the art may now make numerous uses and modifications of the specific embodiments described, without departing from the inventive concepts. For example, the present invention describes making the decoys of particular materials and moving the waterfowl decoys in a particular manner; however, it is evident that those skilled in the art may utilize other materials and/or move the decoys in different movements without departing from the inventive concepts herein disclosed. This method can be combined with other processes to provide variations on the method described. It is also evident that the steps recited may in some instances be performed in a different order; or equivalent structures and processes may be substituted for the various structures and processes described. Consequently, the specification is to be construed as exemplary and not limiting and the scope of the invention as described by the claims.

I claim:

1. A waterfowl decoy system comprising:
a wing-shaped body, and
a handle.

2. A decoy as in claim 1 wherein said wing-shaped body comprises a rigid plastic.

3. A waterfowl decoy system as in claim 1 wherein said wing-shaped body comprises corrugated plastic.

4. A waterfowl decoy system as in claim 3 wherein said corrugated plastic is Coreplast™.

5. A waterfowl decoy as in claim 1 wherein said wing-shaped body is substantially planar.

6. A waterfowl decoy system as in claim 1 wherein said handle comprises a slot in said wing-shaped body.

7. A waterfowl decoy system as in claim 1 wherein the area of said body adjacent said slot includes a reinforcement.

8. A waterfowl decoy system as in claim 3 wherein said body comprises corrugated plastic and said reinforcement comprises an additional cross-grain section of said corrugated plastic.

9. A waterfowl decoy system as in claim 6 wherein said handle further comprises a padded area adjacent said slot.

10. A waterfowl decoy system as in claim 1 wherein said body contains a window.

11. A waterfowl decoy system as in claim 1 wherein said window is located in said body to facilitate covert viewing of said waterfowl.

12. A waterfowl decoy system as in claim 1 comprising two of said wing-shaped bodies, each of a different size.

13. A waterfowl decoy system as in claim 1 comprising two of said wing-shaped bodies, each of the same size.

14. A waterfowl decoy system as in claim 1 wherein said wing-shaped body is shaped in a form of an extended wing of a waterfowl.

15. A waterfowl decoy system as in claim 14 wherein said waterfowl is selected from the group consisting of ducks and geese.

16. A waterfowl decoy system as in claim 1 and further including an instructional apparatus for instructing a user to imitate with said wing-shaped decoy the flapping motion of a waterfowl.

17. A waterfowl decoy system as in claim 16 wherein said instructional apparatus comprises instructions demonstrating holding said wing aligned in the direction of a waterfowl from the user and holding said wing in a direction perpendicular to the direction of said waterfowl from said user.

18. A waterfowl decoy system as in claim 1 wherein said wing-shaped body is colored.

19. A waterfowl decoy system as in claim 16 wherein said color comprises black.

20. A waterfowl decoy system as in claim 17 wherein said wing-shaped body includes a wing tip, the major portion of said body is colored white and said wing tip is colored black.

21. A waterfowl decoy system comprising:
a wing-shaped body;
a handle; and
an instructional apparatus for instructing a user to imitate with said wing-shaped decoy the flapping motion of a waterfowl.

22. A waterfowl decoy system as in claim 21 wherein said instructional apparatus comprises instructions demonstrating holding said wing aligned in the direction of a waterfowl from the user and holding said wing in a direction perpendicular to the direction of said waterfowl from said user.

23. A waterfowl decoy system comprising:
a substantially planar, wing-shaped, rigid body; and
a handle formed in said body.

24. A waterfowl decoy system as in claim 23 wherein said handle comprises a slot in said wing-shaped body.

25. A waterfowl decoy system as in claim 24 wherein the area of said body adjacent said slot includes a reinforcement.

26. A waterfowl decoy system as in claim 25 wherein said body comprises corrugated plastic and said reinforcement comprises an additional cross-grain section of said corrugated plastic.

27. A waterfowl decoy system as in claim 23 wherein said body contains a window facilitating the covert viewing of said waterfowl.

28. A waterfowl decoy system as in claim 23 comprising two of said wing-shaped bodies, each of a different size.

29. A waterfowl decoy system as in claim 23 comprising two of said wing-shaped bodies, each of the same size.

30. A method for attracting waterfowl to a particular location comprising:
providing a wing-shaped body having a handle;
grasping said handle; and
moving said wing shaped body in a flapping motion.

31. A method according to claim 30 wherein said flapping motion comprises moving said wing-shaped decoy from a first position and a second position.

32. A method according to claim 31 wherein said first position comprises a position in which said body is aligned substantially in the direction of a waterfowl from the user.

33. A method according to claim 31 wherein said second position comprises a position in which said body is aligned in a direction substantially perpendicular to the direction of a waterfowl from the user.

34. A method according to claim 30 wherein said providing comprises providing a first wing-shaped decoy and a second wing-shaped decoy smaller than said first wing-shaped decoy, and wherein said grasping and moving comprises first grasping and moving said first wing-shaped decoy, and then as an attracted waterfowl flies closer, grasping and moving said second wing shaped decoy.

35. A method as in claim 28, and further comprising viewing an attracted waterfowl through a window in said decoy.
